(19) United States
(12) Patent Application Publication
(10) Pub. No.: US 2018/0363791 A1
(43) Pub. Date: Dec. 20, 2018

(54) PRESSURE VALVE AND PRESSURE RELEASING ASSEMBLY FOR THE SAME

(71) Applicant: BANZA STAMPING INDUSTRY CORP., Su'ao Township (TW)

(72) Inventors: Li-Wei Chen, Su'ao Township (TW); Cole Krebs, Su'ao Township (TW)

(73) Assignee: BANZA STAMPING INDUSTRY CORP., Su'ao Township (TW)

(21) Appl. No.: 15/623,569

(22) Filed: Jun. 15, 2017

(51) Int. Cl. F16K 17/04

(52) U.S. Cl. CPC F16K 17/048; G05D 16/106; F16K 17/046

(57) ABSTRACT

A pressure releasing assembly has a hollow shell with a gap formed through an end and a main notch formed therein and communicating with the gap. A slide is mounted slidably in the shell and an airproof element mounted between the inner wall of the shell and the slide to keep the air from leaking through the space between the slide and the inner wall of the shell. When the slide is moved rapidly because of the excessively high air pressure, the airproof element is moved along with the slide and then is received in the main notch. Then a space is resulted between the wall of the main notch and the airproof element to allow the gas to leak out from the gap. Therefore, the air pressure is reduced rapidly to keep the component from being damaged.

### BACKGROUND OF THE INVENTION

### 1. Field of the Invention

The present invention relates to a pressure releasing assembly, and more particularly to a pressure releasing assembly for a pressure valve that immediately exhausts excessively high pressure.

### 2. Description of the Prior Arts

Pressure valves are used to reduce the input pneumatic pressure to a desired output pneumatic pressure and are used widely in various devices. A piston is mounted movably between the inlet and the outlet to selectively stop the gas flow from a pressure gas source to a downstream device. However, when the conventional pressure valve is suffering from excessively high air pressure, the inner component of the conventional pressure valve is pushed by the excessively high air pressure causing damage.

To overcome the shortcomings, the present invention provides a pressure releasing assembly for a pressure valve to mitigate or obviate the aforementioned problems.

### SUMMARY OF THE INVENTION

The main objective of the present invention is to provide a pressure releasing assembly for a pressure valve to rapidly reduce the excessively high air pressure. The pressure releasing assembly has a hollow shell with a gap formed through an end and a main notch formed therein and communicating with the gap. A slide is mounted slidably in the shell and an airproof element mounted between the inner wall of the shell and the slide to keep the air from leaking through the space between the slide and the inner wall of the shell. When the slide is moved rapidly due to excessively high air pressure, the airproof element is moved along with the slide and then is received in the main notch. Then a space is caused between the wall of the main notch and the airproof element to allow the gas to leak out from the gap. Therefore, the air pressure is reduced rapidly to keep the component from being damaged.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pressure valve in accordance with the present invention;

FIG. 2 is an exploded perspective view of the pressure valve in FIG. 1;

FIG. 3 is another exploded perspective view of the pressure valve in FIG. 1;

FIG. 4 is an enlarged cross sectional view of a shell of the pressure valve in FIG. 1; and

FIGS. 5A to 5C are enlarged operational views in partial section of the pressure valve in FIG. 1

### DETAILED DESCRIPTION OF THE EMBODIMENTS

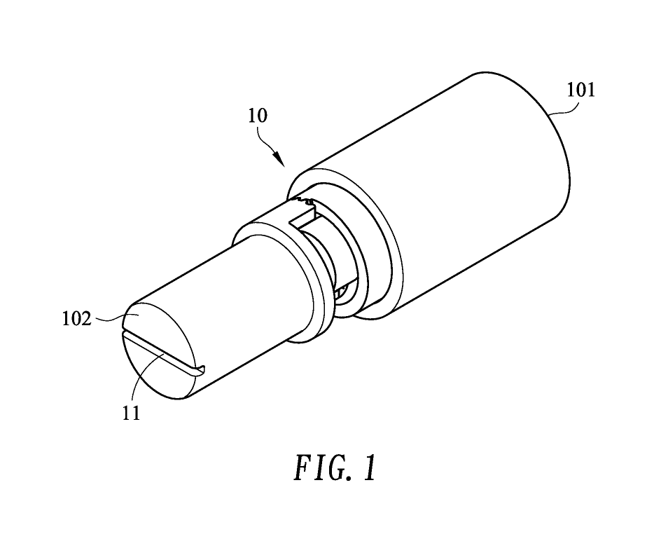

With reference to FIGS. 1 to 3, a pressure valve with a pressure releasing assembly in accordance with the present invention comprises a shell 10, a valve body 20, a slide 30, an airproof element 40 and a resilient element 50.

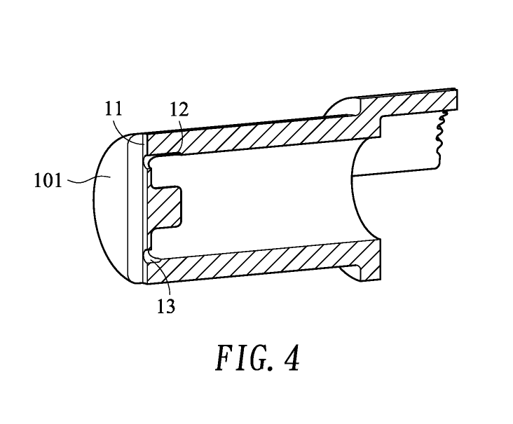

With reference to FIGS. 1 and 4, the shell 10 is hollow and has an inlet end 101, an outlet end 102, an inner wall, a gap 11 and a main notch 12. The gap 11 is formed through the outlet end 102 of the shell 10. The main notch 12 is formed on the inner wall and communicates with the gap 11. In one embodiment, the gap 11 is longitudinally across the outlet end 102 of the shell 10, and the shell 10 has a secondary notch 13. The secondary notch 13 is formed on the inner wall of the shell, is separate from the main notch 12 and communicates with the gap 11. The secondary notch 13 is shorter than and is opposite to the main notch 12. In one embodiment, the shell 10 comprises two halves.

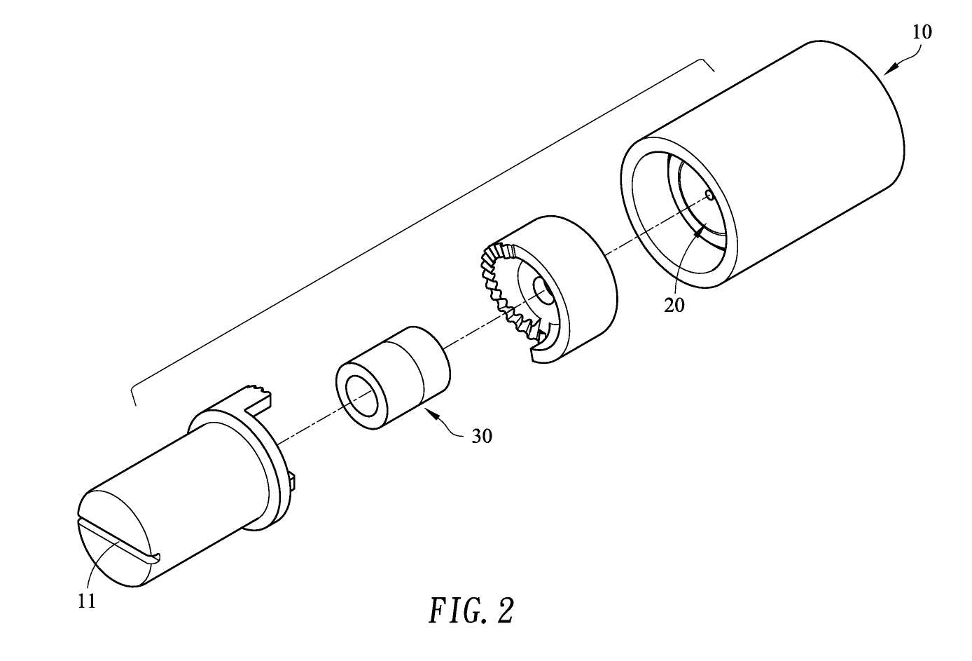

With reference to FIGS. 1 and 2, the valve body 20 is mounted in the shell 10 near the inlet end 101 and selectively stops gas from flowing through the valve body 20.

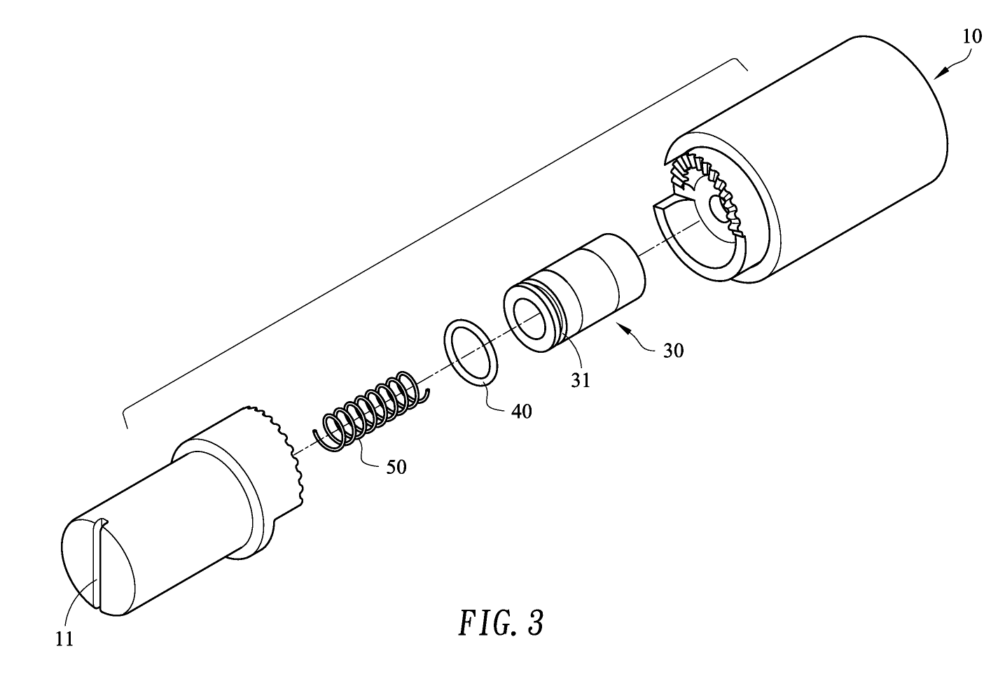

With reference to FIGS. 2 and 3, the slide 30 is mounted slidably in the shell 10 near the outlet end 102. In one embodiment, the slide 30 has an annular recess 31.

The airproof element 40 is mounted between the inner wall of the shell and the slide 30, is attached to the slide 30 and is selectively received in the main notch 12. In one embodiment, the airproof element 40 is an O-ring and is mounted in the annular recess 31 of the slide 30.

The resilient element 50 is mounted in the shell 10 and is clamped between the slide 30 and the outlet end 102 of the shell 10. In one embodiment, the slide 30 has an axial recess 32 to receive the resilient element 50. In one embodiment, the shell 10 has an inner bump 14 and one end of the resilient element 50 is mounted around the inner bump 14 to hold the resilient element 50 linearly. In one embodiment, the resilient element is a spring.

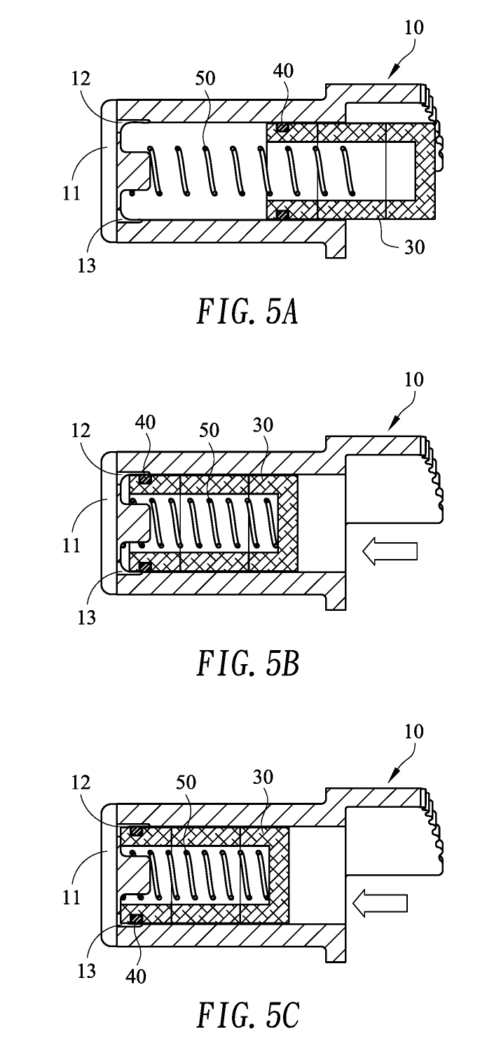

With reference to FIG. 5A, the airproof element 40 abuts against the inner wall of the shell 10 to keep the gas from leaking through.

With reference to FIG. 5B, the pressure valve as described is subjected to an excessively high air pressure so that the slide 30 is pushed to move rapidly. The airproof element 40 is moved along with the slide 30 until the airproof element 40 is received in the main notch 12 of the shell 10. When the airproof element 40 is received in the main notch 12 of the shell 10, the airproof element 40 no longer abuts against the inner wall of the shell 10 to make a space between the wall of the main notch 12 and the airproof element 40. Then the gas leaks out from the gap 11 through the main notch 12 of the shell 10 so that the air pressure is rapidly decreased.

With reference to FIG. 5C, the pressure valve as described is subjected to an even excessively higher air pressure so that the slide 30 is pushed to move even more rapidly. The airproof element 40 is moved along with the slide 30 until the airproof element 40 is received both in the main notch 12 and in the secondary notch 13 of the shell 10. When the airproof element 40 is received in the main notch 12 and in the secondary notch 13 of the shell 10, the airproof element 40 no longer abuts against the inner wall of the shell 10 to make two spaces between the airproof element 40 and the walls of the main notch 12 and the secondary notch 13. Then the gas leaks out from the gap 11 through the main notch 12 and the secondary notch 13 of the shell 10. Since the gas leaks through both of the main notch 12 and the secondary notch 13, the air pressure decreases more rapidly.

When the air pressure in the pressure valve decreases to the predetermined pressure, the resilient element 50 pushes the slide 30 back to the normal position.

With the gap 11, the main notch 12, the slide 30 and the airproof element 40 to form a pressure releasing assembly, the excessively high air pressure is easily relieved by leaking gas through the main notch 12. Therefore, the pressure valve as described does not harm by the excessively high air pressure.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pressure releasing assembly comprising:
a hollow shell having
an outlet end;
an inner wall;
a gap formed through the outlet end; and
a main notch formed on the inner wall and communicating with the gap;
a slide mounted slidably in the shell near the outlet end;
an airproof element mounted between the inner wall of the shell and the slide, attached to the slide and selectively received in the main notch; and
a resilient element mounted in the shell and clamped between the slide and the outlet end of the shell.

2. The pressure releasing assembly as claimed in claim 1, wherein
the gap of the shell is longitudinally across the outlet end of the shell; and
the shell has a secondary notch formed on the inner wall of the shell, being separate from the main notch and communicating with the gap.

3. The pressure releasing assembly as claimed in claim 1, wherein
the slide has an annular recess; and
the airproof element is mounted in the annular recess.

4. The pressure releasing assembly as claimed in claim 2, wherein
the slide has an annular recess; and
the airproof element is mounted in the annular recess.

5. The pressure releasing assembly as claimed in claim 1, wherein the airproof element is an O-ring.

6. The pressure releasing assembly as claimed in claim 2, wherein the airproof element is an O-ring.

7. The pressure releasing assembly as claimed in claim 3, wherein the airproof element is an O-ring.

8. The pressure releasing assembly as claimed in claim 4, wherein the airproof element is an O-ring.

9. The pressure releasing assembly as claimed in claim 1, wherein the slide has an axial recess to receive the resilient element.

10. The pressure releasing assembly as claimed in claim 1, wherein
the shell has an inner bump; and
one end of the resilient element is mounted around the inner bump.

11. A pressure valve comprising:
a hollow shell having
an inlet end;
an outlet end;
an inner wall;
a gap formed through the outlet end; and
a main notch formed on the inner wall and communicating with the gap;
a valve body mounted in the shell near the inlet end and selectively stopping gas from flowing through the valve body;
a slide mounted slidably in the shell near the outlet end;
an airproof element mounted between the inner wall of the shell and the slide, attached to the slide and selectively received in the main notch; and
a resilient element mounted in the shell and clamped between the slide and the outlet end of the shell.

12. The pressure valve as claimed in claim 11, wherein
the gap of the shell is longitudinally across the outlet end of the shell; and
the shell has a secondary notch formed on the inner wall of the shell, being separate from the main notch and communicating with the gap.

13. The pressure valve as claimed in claim 11, wherein
the slide has an annular recess; and
the airproof element is mounted in the annular recess.

14. The pressure valve as claimed in claim 12, wherein
the slide has an annular recess; and
the airproof element is mounted in the annular recess.

15. The pressure valve as claimed in claim 11, wherein the airproof element is an O-ring.

16. The pressure valve as claimed in claim 12, wherein the airproof element is an O-ring.

17. The pressure valve as claimed in claim 13, wherein the airproof element is an O-ring.

18. The pressure valve as claimed in claim 14, wherein the airproof element is an O-ring.

19. The pressure valve as claimed in claim 11, wherein the slide has an axial recess to receive the resilient element.

20. The pressure valve as claimed in claim 11, wherein
the shell has an inner bump; and
one end of the resilient element is mounted around the inner bump.
